(19) United States
(12) Patent Application Publication
(10) Pub. No.: US 2021/0250941 A1
(43) Pub. Date: Aug. 12, 2021

(54) METHOD AND APPARATUS FOR INTRA-NODE RESOURCE ALLOCATION

(71) Applicant: Nokia Solutions and Networks Oy, Espoo (FI)

(72) Inventors: Esa Tiirola, Kempele (FI); Keeth Saliya Jayasinghe Laddu, Espoo (FI); llkka Keskitalo, Oulu (FI)

(21) Appl. No.: 16/973,213

(22) PCT Filed: Dec. 30, 2019
(86) PCT No.: PCT/FI2019/050923

§ 371 Date: Dec. 8, 2020

Related U.S. Application Data
(60) Provisional application No. 62/789,606, filed on Jan. 8, 2019.

(51) Int. Cl. H04W 72/04; H04W 72/02; H04W 4/40

(52) U.S. Cl. CPC H04W 72/0426; H04W 72/0446; H04W 4/40; H04W 72/0493; H04W 72/02

(57) ABSTRACT

Solutions for resource allocation are proposed. In an embodiment, a method comprises: obtaining a first resource configuration for at least one time domain resource, the first resource configuration indicating a first resource type for a first function part of an apparatus; obtaining a second resource configuration for the at least one time domain resource, the second resource configuration indicating a second resource type for a second function part of the apparatus; and determining an operation mode for the apparatus for the at least one time resource, based on a predefined rule, the first resource configuration and the second resource configuration. In some embodiments, the predefined rule may comprise: in response to the first resource type being Soft and the at least one time resource being not occupied by the second function part, determining a first operation mode for the apparatus where the second function part does not transmit or receive and the first function part is available for transmission or reception.

### CROSS REFERENCE TO RELATED APPLICATION

This application claims the benefit of U.S. Provisional Application No. 62/789,606 entitled “METHOD AND APPARATUS FOR INTRA-IAB RESOURCE ALLOCATION” filed on Jan. 8 2019, which is incorporated herein by reference in its entirety.

### TECHNICAL FIELD

The teachings in accordance with example embodiments of this disclosure relate generally to integrated access and backhaul (IAB), more specifically, relate to intra-IAB node resource configuration.

### BACKGROUND

This section is intended to provide a background or context to the disclosure that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

ACK Acknowledgement

ADL Access DL

BH Backhaul

BSR Buffer Status Report

CDL Child DL

CP Control Plane

CSI Channel State Information

CU Central Unit

DCI Downlink Control Information

DgNB Donor gNB

DL Downlink

DU Distributed unit

eMBB Enhanced Mobile BroadBand

F Flexible

F1-C F1 (interface between CU and DU) control

F1-AP F1 interface—application protocol

GP Guard Period

HARQ Hybrid Automatic Repeat ReQuest

IAB Integrated Access and Backhaul

ID Identity

INA DU resource is explicitly or implicitly indicated as not available

MAC Medium Access Control

MAC CE MAC Control Element

MT Mobile termination

NGC Next Generation Core

NA Not Available

NR New Radio (5G Radio)

OAM Operations, Administration and Maintenance

PDCCH Physical Downlink Control Channel

PDL Parent DL

PDSCH Physical Downlink Shared Channel

PRACH Physical Random Access Channel

PRB Physical Resource Block

PUCCH Physical Uplink Control Channel

PUL Parent UL

PUSCH Physical Uplink Shared Channel

QPSK Quadrature Phase Shift Keying

RN Relay Node (self-backhaul node)

RRC Radio Resource Control

Rx Receiver

RS Reference Signal

SFI Slot Format Indication

SDM Space Division Multiplexing

SSB Synchronization Signal Block

TDM Time Division Multiplexing

Tx Transmission

UCI Uplink Control Information

UL Uplink

URLLC Ultra Reliable Low Latency Communication

The 5G NR operation can allow network deployment with minimized manual efforts and as automated a self-configuration as possible. Especially on higher frequency bands the coverage will be problematic and specific capabilities are needed for NR to enable effortless coverage extensions with minimized/none requirements for network (re-)planning in a fast and cost-effective manner.

For these reasons, 3GPP is specifying capabilities enabling wireless backhauling for NR sites that do not have fixed (wired/fiber) connection to the network. Using radio connection for backhauling to eliminate the need for cabling of all sites of the radio network (which can be very dense) which will dramatically reduce the initial deployment costs.

Example embodiments of the present disclosure focuses on improvements in resource allocation on backhaul and access connections. In some embodiments, multi-hop relaying in an Integrated Access and Backhaul deployment is considered during the resource allocation.

### SUMMARY

In general, example embodiments of the present disclosure provide solutions for resource allocation and control of operation of a device.

In a first aspect, there is provided an apparatus. The apparatus comprises at least one processor, and at least one memory including computer program code. The at least one memory and the computer program code are configured, with the at least one processor, to cause the apparatus to perform at least the following: obtaining a first resource configuration for at least one time domain resource, the first resource configuration indicating a first resource type for a first function part of the apparatus, the first resource type being one of: Hard, Soft and Not Available; obtaining a second resource configuration for the at least one time domain resource, the second resource configuration indicating a second resource type for a second function part of the apparatus, the second resource type being one of: Downlink, Uplink and Flexible; and determining an operation mode for the apparatus for the at least one time resource, based on a predefined rule, the first resource configuration and the second resource configuration. In some embodiments, the predefined rule comprises: in response to the first resource type being Soft and the at least one time resource being not occupied by the second function part, determining a first operation mode for the apparatus where the second function part does not transmit or receive and the first function part is available for transmission or reception.

In a second aspect, there is provided a method. The method may be implemented by an apparatus. The method comprises: obtaining a first resource configuration for at least one time domain resource, the first resource configuration indicating a first resource type for a first function part of the apparatus, the first resource type being one of: Hard, Soft and Not Available; obtaining a second resource configuration for the at least one time domain resource, the second resource configuration indicating a second resource type for a second function part of the apparatus, the second resource type being one of: Downlink, Uplink and Flexible; and determining an operation mode for the apparatus for the at least one time resource, based on a predefined rule, the first resource configuration and the second resource configuration. In some embodiments, the predefined rule comprises: in response to the first resource type being Soft and the at least one time resource being not occupied by the second function part, determining a first operation mode for the apparatus where the second function part does not transmit or receive and the first function part is available for transmission or reception.

In a third aspect, there is a provided an apparatus. The apparatus comprises means for performing operations of the method of the second aspect.

In a fourth aspect, there is provided a computer product. The computer product comprises instructions that when executed by an apparatus, cause the apparatus to perform a method according to the second aspect.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1A shows FIG. 7.3.1-1 of 3GPP TR 38.874 1.0.0 (2018-12): Different IAB link types;

FIG. 1B shows FIG. 6.3.1-1 of 3GPP TR 38.874 1.0.0 (2018-12): Reference diagram for architecture 1a (SA-mode with NGC);

FIG. 2A shows an IAB architecture in a wireless communication system applying a CU/DU split where the CU is located in the Donor and each IAB node hosts a DU part;

FIG. 2B is a block diagram of possible internal structure of an IAB node;

FIG. 3A shows Table 7.3.3.1 of 3GPP TR 38.874 1.0.0 (2018-12);

FIG. 3B shows Table 7.3.3-2 of 3GPP TR 38.874 1.0.0 (2018-12);

FIG. 4A and FIG. 4B each show a method in accordance with example embodiments of the disclosure which may be performed by an apparatus;

FIG. 5 shows a flow type diagram for illustrating examples of predefined rules for determining DU/MT operation at the IAB node, and TDM between parent and child links according to example embodiments of the disclosure;

FIG. 6 shows an example of valid and invalid resource combinations for an IAB node when the DU part has been configured as Soft resource according to embodiments of the present disclosure;

FIG. 7 shows a flow type diagram for illustrating further examples of predefined rules for determining DU/MT operation at the IAB node, TDM between parent and child links according to example embodiments of the disclosure; and

FIG. 8 shows the categorization of DU resources as Hard, Soft, and NA as in accordance with example embodiments of the disclosure.

### DETAILED DESCRIPTION

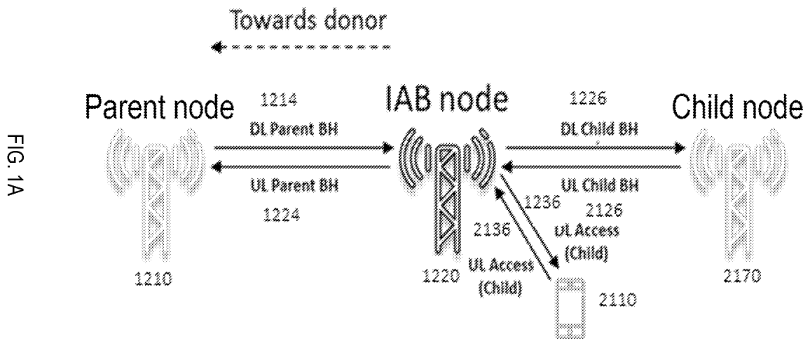

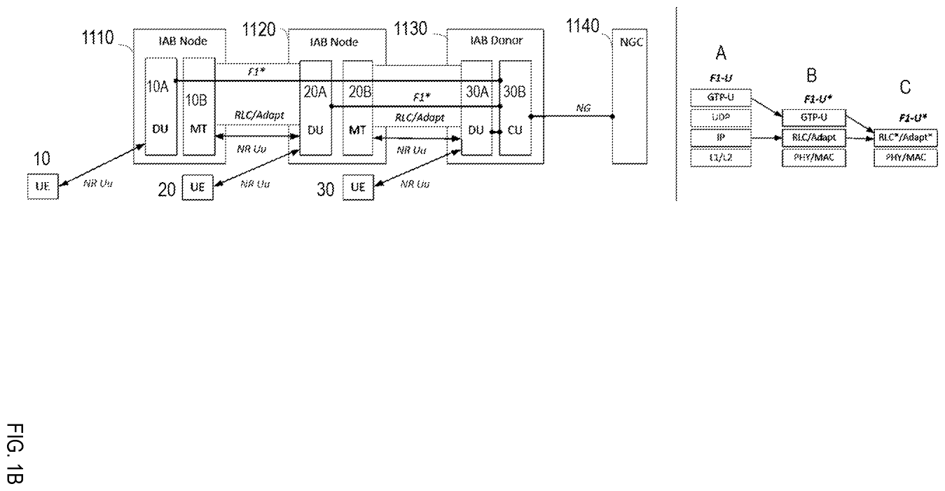

In the present disclosure, there is proposed novel methods and apparatuses related to integrated access and backhaul (IAB) configuration. Specifically, some embodiments are related to an IAB resource configuration in a case of IAB architecture Option 1a shown in FIG. 1B.

Example embodiments of this disclosure focus on the resource allocation on the BH and access connections. In some embodiments, multi-hop relaying in the IAB deployment is taken into consideration during the resource allocation. The aim is to define a robust operation while providing flexibility to adapt the capacity needs on both BH and access links.

IAB Scenarios:

The 5G NR is expected to be able to allow network deployment with minimized manual efforts and as automated self-configuration as possible. On higher frequency bands where the coverage is problematic, specific capabilities may be needed for NR to enable effortless coverage extensions with minimized/none requirements for network (re-)planning in a fast and cost-effective manner. For these reasons, 3GPP is specifying capabilities enabling wireless backhauling for NR sites that do not have fixed (wired/fiber) connection to the network. Using radio connection for backhauling may eliminate the need for cabling of all sites of the radio network (which can be very dense) which dramatically reduces the initial deployment costs.

Furthermore, an intention is to use the same carrier for both backhaul and access links sharing the same radio resources and radio transceivers. This is called self-backhauling, or in 3GPP terms IAB. Frequency bands with sufficient capacity, i.e. large enough carrier bandwidths, are especially applicable for IAB. Obviously, examples of such frequency bands include those carriers on mmWave bands and typically TDD bands. Therefore, a design of IAB shall consider the half-duplex constraint, i.e. no simultaneous transmission and reception to avoid excessive interference between transmitter and receiver.

Yet another requirement for IAB is the support for multi-hop relaying where an IAB node may provide wireless BH link for the next hop IAB node. The serving node providing the BH connection is called a parent node. The serving node may be either a donor node (with wired network connection), or another IAB node. The served IAB node is called a child node.

Although a focus of certain example embodiments of the present disclosure is on self-backhauling, it should be noted that a proposed solution in accordance with the example embodiments is equally applicable to different out-of-band backhauling scenarios. For example, it may cover also multi-hop scenarios where backhaul and access links are operating at different carrier frequencies.

IAB Architecture:

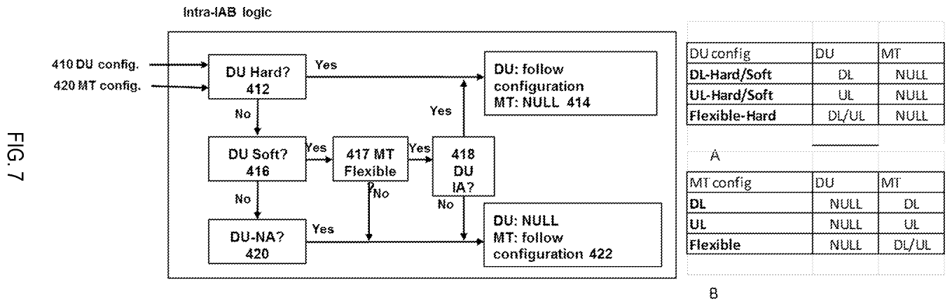

FIG. 1A shows FIG. 7.3.1-1 of 3GPP TR 38.874 1.0.0 (2018-12). It shows basic connections between a Parent Node 1210, the IAB nodes, and access UEs. From the middle IAB node 1220 perspective, there will be parent BH links including DL Parent BH 1214 and UL Parent BH 1224 as well as child BH and access links including DL Child BH 1226 and UL Child BH 2126 to Child node 2170; and child BH and access links including DL access (Child) 1236 and UL Access (Child) 2136 to UE 2110, all for both UL and DL.

In FIG. 1A, an Access link type and a Backhaul link type are supported for IAB. As shown in FIG. 1A there are basic connections between the IAB node 1220 and an access UE 2110. As shown in FIG. 1A these parent BH links may include DL Parent BH 1214, UL Parent BH 1224; the child BH links may include DL Child BH 1226 and UL Child BH 2126; and the access links can include the link for the DL Access (Child) 1236 and UL Access (Child) 2136 with the UE 2110. As shown in FIG. 1A, the DL Parent BH 1214 and UL Parent BH 1224 of IAB node 1220 are communicated with the donor node (IAB Donor), in this case the Parent node 1210.

Depending on the topology/architectures the IAB-node may have its functions for UL/DL access and child BH respectively in the same location or different locations, and for a given BH link for an IAB-node, it may be a parent BH or a child BH, depending on the topology/architecture.

Further, downlink IAB-node transmissions (i.e. transmissions on backhaul links from an IAB-node to child IAB-nodes served by the IAB-node and transmissions on access links from an IAB-node to UEs served by the IAB-node) may be scheduled by the IAB-node itself. Uplink IAB transmission (transmissions on a backhaul link from an IAB-node to its parent IAB-node or IAB-donor) may be scheduled by the parent IAB-node or IAB-donor.

In some example embodiments of the present disclosure, an IAB node (e.g., the IAB node 1220 in FIG. 1A) includes two separate parts:
MT (mobile termination) part, which facilitates Parent BH connections between the Parent node and IAB node;
DU (distributed unit) part, which facilitates Child connections between IAB node and Child node as well as between IAB node and UE terminals (connected to the IAB node via Access link).

It is noted that the acronym MT as used herein can be used to refer to the 3GPP official term Mobile termination as defined in TS 21.905. Or else the acronym MT can refer to the generally defined term “Mobile Termination (MT) where the Mobile Termination is the component of the Mobile Equipment (ME) which supports functions specific to management of the PLMN access interface (3GPP or non-3GPP). The MT is realized as a single functional entity.”

Further, without limitation, in some example embodiments of the present disclosure, the IAB node may have an architecture as shown in FIG. 1B.

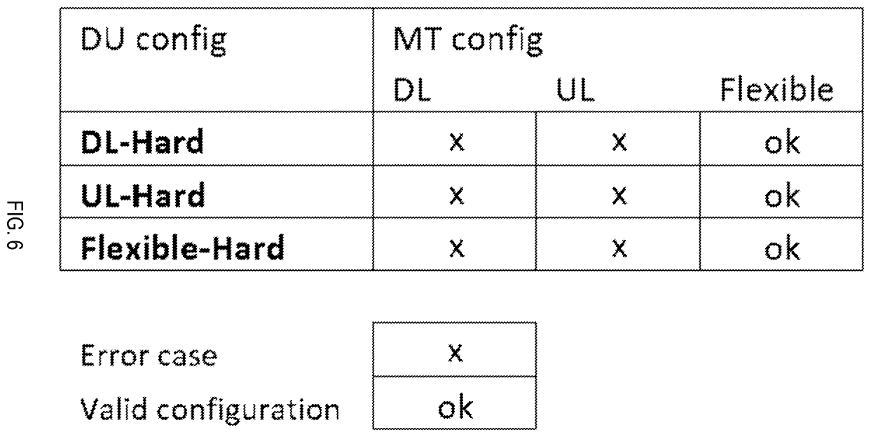

There are different options for the IAB architecture. FIG. 1B shows FIG. 6.3.1-1 of 3GPP TR 38.874 1.0.0 (2018-12) which is showing a high-level architecture 1a for layer 2 (L2) relaying with a distributed base station, i.e. gNB, architecture which has been adopted as a basis for normative work in 3GPP for IAB.

The architecture 1a leverages CU/DU-split architecture. FIG. 1B shows the reference diagram for a two-hop chain of IAB-nodes underneath an IAB-donor 1130, where IAB-node 1110 and/or 1120 and UEs 10, 20, and/or 30 as in FIG. 1B connect in SA-mode to an NGC 1140.

As in 3GPP, in this example architecture as shown in FIG. 1B each IAB-node 1110 and IAB-node 1120 holds a DU and an MT. For example, as shown in FIG. 1B the IAB-node 1110 holds DU 10A and MT 10B; and the IAB-node 1120 holds DU 20A and MT 20B. Via an MT, the IAB-node 1110 and/or 1120 each connect to an upstream IAB-node or the IAB-donor 1130 as in FIG. 1B. Via the DU, the IAB-node 1110 and/or 1120 establishes RLC-channels to UEs 10, 20, and/or 30 and to MTs of downstream IAB-nodes. The IAB-node 1110 and/or 1120 as in FIG. 1B can connect to more than one upstream IAB-node or IAB-donor DU. The IAB-node DU has F1-C connection only with one IAB-donor CU-CP. It is noted that the IAB MT may have dual-/multi-connection to more than one parent node. Also, the IAB node may have multiple BH connections to more than one downstream/child nodes (tree topology).

The IAB donor 1130 also holds a DU 30A to support UEs and MTs of downstream IAB-nodes. The IAB-donor holds a CU 30B for the DUs of all IAB-nodes 1110 and/or 1120 and for its own DU 30A. It is assumed that the DU on an IAB-node are served by only one CU of the IAB-donor. This IAB-donor may change through topology adaptation. The DU on an IAB-node connects to the CU in the IAB-donor using a modified form of F1 over the wireless BH connection(s), which is referred to as F1*. F1*-U (user plane part of the F1*) is established between the DU part of the serving IAB-node and the CU part of the donor. The F1* is relayed over RLC channels on each hop of the BH connection. An adaptation layer is added, which holds routing information, enabling hop-by-hop forwarding. It replaces the IP functionality of the standard F1-stack. F1*-U may carry a GTP-U (user plane of the GPRS Tunneling Protocol) header for the end-to-end association between CU and DU. In a further enhancement, information carried inside the GTP-U header may be included into the adaption layer. Further, optimizations to RLC may be considered such as applying ARQ only on the end-to-end connection opposed to hop-by-hop. The right side of FIG. 1B shows examples of such F1*-U protocol stacks. These example protocol stacks include FI-U for the wired connection within the IAB donor, and two options (A and B) for the modified FI-U*. The MT of each IAB-node 1110 and/or 1120 as in FIG. 1B further sustains NAS connectivity to the NGC 1140, e.g., for authentication of the IAB-node. It may further sustain a PDU-session via the NGC 1140, e.g., to provide the IAB-node 1110 and/or 1120 with connectivity to the OAM. The CU-DU interface carries also the control plane signalling (F1-C/F1-AP) over the established F1/F1* connection. The F1-AP (F1 Application Protocol) is used for configuring the DU part as well as transferring RRC messages.

For NSA operation with EPC, the MT is dual-connected with the network using EN-DC where the CP is over the LTE connection and BH is over the NR connection. Alternatively, the IAB node may have only NR connection for both CP and BH data where (some of the) NGC functions are required to control the NR link.

The IAB donor 1130 as in FIG. 1B hosts the centralized unit (CU) 30B for all IAB nodes, i.e. it runs RRC, higher L2 (e.g., PDCP) and control functions for the subtending IAB topology. Distributed units (DUs) residing at the IAB-node 1110 and/or 1120 host lower L2 protocol layers (e.g., RLC, MAC) and the physical (PHY) layer. The CU 30B has basically two control interfaces to the IAB nodes (e.g., IAB nodes 1110 and 1120), namely RRC connection to the IAB-MT and F1-C to the IAB-DU. Hence, both RRC signalling and F1-AP are available for the IAB configuration and control. With this architecture the radio resources usage can have central coordination by the donor CU.

IAB Resource Coordination:

Resource allocation on the BH and access connections is a problem to be solved. Some agreements on resource allocation have been made in 3GPP, and some descriptions related to resource coordination in 3GPP TR 38.874 1.0.0 are reproduced below:
“From an IAB-node MT point-of-view, as in Rel. 15, the following time-domain resources can be indicated for the parent link:
   Downlink time resource
   Uplink time resource
   Flexible time resource
From a IAB-node DU point-of-view, the child link has the following types of time resources:
   Downlink time resource
   Uplink time resource
   Flexible time resource
   Not available time resources (resources not to be used for communication on the DU child links)
Each of the downlink, uplink and flexible time-resource types of the DU child link can belong to one of two categories:
   Hard: The corresponding time resource is always available for the DU child link
   Soft: The availability of the corresponding time resource for the DU child link is explicitly and/or implicitly controlled by the parent node.
[ . . . ]
In order to support mechanisms for resource allocation for IAB nodes, semi-static configuration is supported for the configuration of IAB node DU resources. In addition, dynamic indication (L1 signalling) to an IAB node of the availability of soft resources for an IAB node DU is supported. Existing Rel.15 L1 signalling methods as the baseline, while potential enhancements (e.g. new slot formats), rules for DU/MT behaviour in case of conflicts across multiple hops, and processing time constraints at the IAB node may need to be considered.
Tables 7.3.3-1 and 7.3.3-2 capture the possible combinations of DU and MT behavior. The tables assume an IAB not capable of full-duplex operation. In the tables below the following definitions apply:
   “MT: Tx” means that the MT should transmit if scheduled
   “DU: Tx” means that the DU may transmit
   “MT: Rx” means that the MT should be able to receive (if there is anything to receive)
   “DU: Rx” means that the DU may schedule uplink transmissions from child nodes or UEs
   “MT: Tx/Rx” means that the MT should transmit if scheduled and should be able to receive, but not simultaneously
   “DU: Tx/Rx” means that the DU may transmit and may schedule uplink transmission from child nodes and UEs, but not simultaneously
   “IA” means that the DU resource is explicitly or implicitly indicated as available
   “INA” means that the DU resource is explicitly or implicitly indicated as not available
   “MT: NULL” means that the MT does not transmit and does not have to be able to receive
   “DU: NULL” means that the DU does not transmit and does not schedule uplink transmission from child nodes and UEs Table 7.3.3-1 applies in case of TDM operation, where there can be no simultaneous transmission in the DU and the MT, nor any simultaneous reception in the DU and the MT.
[ . . . ]
Table 7.3.3-2 applies in case of SDM operation, where there can be simultaneous transmission in the DU and the MT, alternatively simultaneous reception in the DU and the MT.”

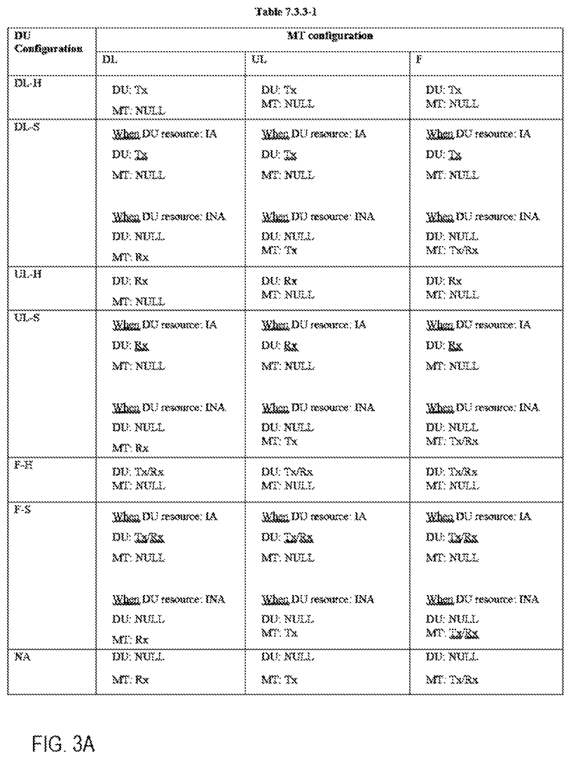

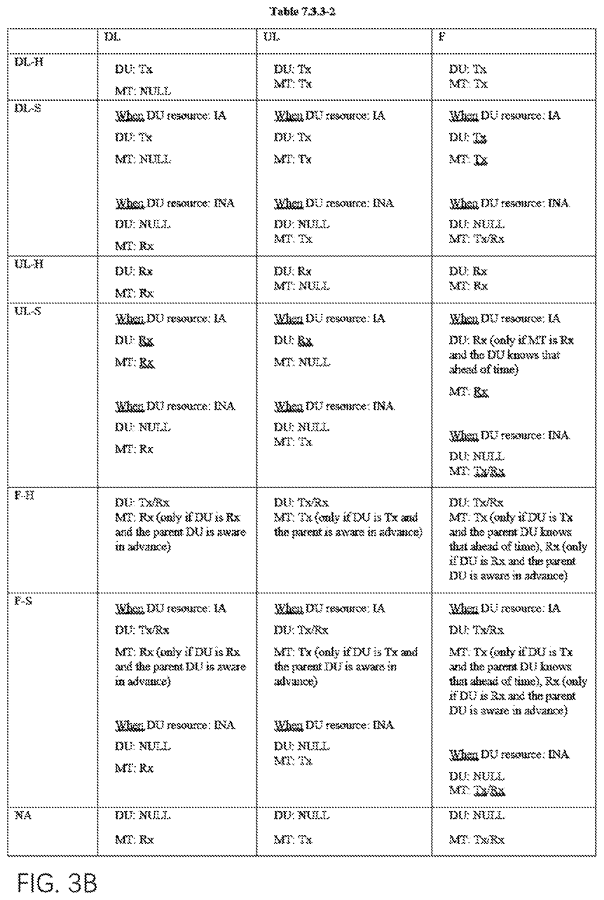

Tables 7.3.3-1 and 7.3.3-2 of 3GPP TR 38.874 v1.0.0 are reproduced in FIG. 3A and FIG. 3B of the present disclosure.

In particular, FIG. 3A of shows Table 7.3.3-1 of 3GPP TR 38.874 which illustrates DU and MT behavior in case of TDM operation, where there can be no simultaneous transmission in the DU and the MT of an IAB node, nor any simultaneous reception in the DU and the MT.

FIG. 3B of the present disclosure shows Table 7.3.3-2 of 3GPP TR 38.874 which shows DU and MT behavior in case of SDM operation, where there can be simultaneous transmission in the DU and the MT of an IAB node, alternatively simultaneous reception in the DU and the MT. The tables assume an IAB not capable of full-duplex operation.

Even with the above agreement in 3GPP, some problems on resource allocation are still open. For example, if resource configuration is performed separately for DU and MT parts of an IAB node, and separately for each IAB node, then how to ensure that resource configuration is consistent at the IAB node while providing means for adaptation for traffic needs by enabling dynamic/semi-static allocation of radio resources to different links

Another problem to be addressed relates to backwards compatibility, i.e., how to ensure that the MT part of an IAB node could follow NR Rel-15 rules with minimum (e.g., or no) change. For example, additional specification, hardware and development effort (/cost) compared to NR Rel-15 UE functionality should be minimized.

Still another problem to be addressed relates to capabilities of the IAB node. Resource allocation should avoid resource conflicts between DU and MT parts of the IAB node, while operating under half-duplex constraint (i.e. simultaneous transmission and reception is not allowed at the IAB node).

To solve at least some of the above problems and other potential problems, methods and apparatuses are proposed in the present disclosure.

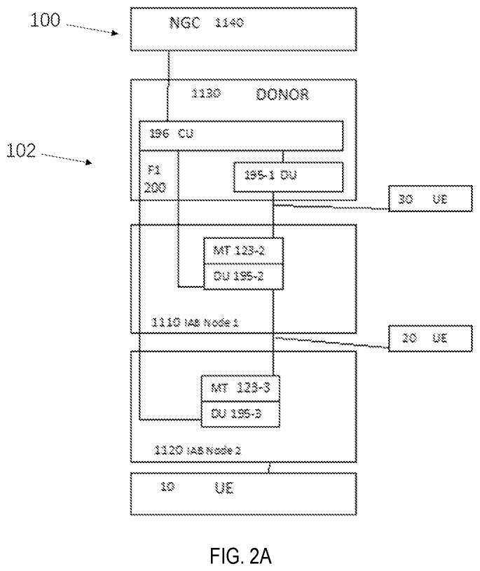

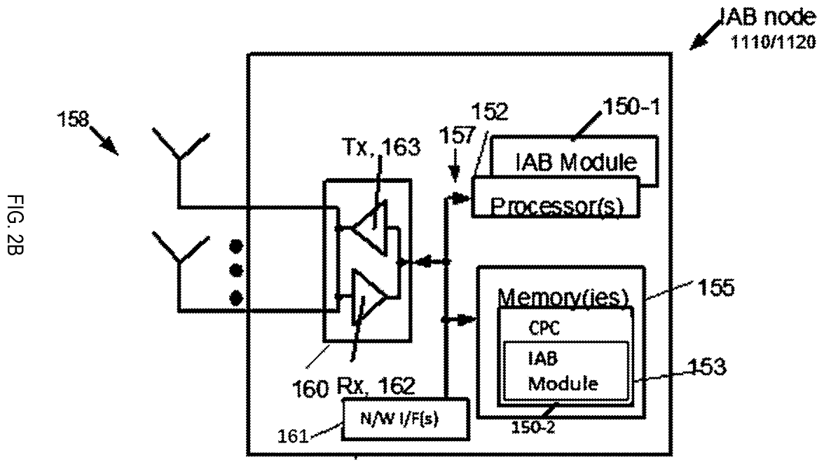

Before describing example embodiments of the disclosure in details, reference is made to FIGS. 2A and 2B for illustrating simplified block diagrams of various electronic devices that are suitable for use in practicing the example embodiments of this disclosure.

Turning to FIG. 2A, FIG. 2A illustrates an IAB architecture 102 in a wireless communication system 100 applying a CU/DU split where a CU is located in the Donor and each IAB node hosts a DU part. Specifically, there is a core network element, for example a 5G core network (NGC) 1140, to which the IAB donor node 1130 connects via a fixed link. The IAB architecture 102 is similar to two-hop IAB network, but is directed to a type of 5G architecture. The IAB architecture 102 comprises the IAB donor node 1130 and the two IAB nodes 1110 and 1120. The IAB donor node 1130 comprises a central unit (CU) 196 and a distributed unit (DU) 195-1. The CU 196 is a logical node hosting Service Data Application Protocol (SDAP) and Packet Data Convergence Protocol (PDCP) user plane protocols, and RRC protocol on the control plane of the gNB that controls the operation of one or more MTs and access UEs. The CU 196 terminates the F1 interface connected with the DU 195-1. A DU 195-1 is a logical node hosting RLC, MAC and PHY layers, and its operation is partly controlled by a CU 196. One CU 196 supports one or multiple cells. Each IAB node 1110 and 1120 comprises Mobile Termination (MT) functional entity 123-2 and 123-3 (referred to mainly as MT 123 herein), respectively, and a DU 195-2, 195-3, respectively. The DU 195-2, 195-3, and/or 195-1 are connected with F1/F1* to the donor directly or via a a parent IAB node. The IAB DU 195-2 or 195-3 host the lower protocol layers to serving a cell via which for UE (e.g., UE 10, 20 or 30) IAB MT can have access and establish a connection.

Each IAB node 1110 and 1120 has a corresponding MT 123-2, 123-3, respectively, which is establishing a connection via a serving (parent) node for control signaling and/or user plane data transmission, carries out RRM measurements and related reporting to the serving node, and performs generally similar functions as the access UEs have typically performed. The user plane (UP) connection is used to carry BH data. There is also the respective logical F1 interface 200 for control towards the donor CU 196. During the initial access when a corresponding IAB node 1110 and/or 1120 is powered up, the corresponding MT 123 scans the detectable cells and selects the best cell to initiate connection set up. The procedure is started with a random access procedure by sending a RACH preamble to the selected node, which responds with a random access response (RAR) message including the initial time alignment information that the MT shall apply in the consequent UL transmissions. The procedure continues by establishing signaling connections (signaling radio bearer(s), SRB(s)) and eventually data radio bearers (DRBs) to carry backhaul data. While being in active operation, the MT 123 of the IAB node shall maintain the connection to the serving (parent) node(s) while performing RRM measurements to detect potential need for a BH link change in case the radio connection is lost or weakened on the active BH connection. Although not shown in the figures, an IAB node may have multi-connectivity to more than one parent node for improved reliability. The MT 123 also receives the timing advance (TA) commands from the serving node to adjust the timing of the UL BH link and to synchronize the DU DL transmission with the parent node DL timing.

Turning to FIG. 2B, this figure is a block diagram of a possible internal structure of an IAB node, for example IAB node 1110 and/or 1120 in FIG. 2A. Each IAB node 1110 and 1120 may include one or more processors 152, one or more memories 155, one or more network interfaces (N/W I/F(s)) 161, and one or more transceivers 160 interconnected through one or more buses 157. Each of the one or more transceivers 160 may include a receiver, Rx, 162 and a transmitter, Tx, 163. The one or more transceivers 160 are connected to one or more antennas 158. The one or more memories 155 include computer program code (CPC) 153. It should be noted that the actual IAB implementation may vary a lot according to the scenario. For example, there can be more than one antenna panels. Each antenna panel may have separate baseband processing. In some embodiments, there may be common baseband processing for multiple antenna panels.

As shown in FIG. 2B, the IAB node 1110 and 1120 may include an IAB module 150, comprising one of or both parts 150-1 and/or 150-2, which may be implemented in a number of ways. The IAB module 150 may be implemented in hardware as IAB module 150-1, such as being implemented as part of the one or more processors 152. The IAB module 150-1 may be implemented also as an integrated circuit or through other hardware such as a programmable gate array. In another example, the IAB module 150 may be implemented as IAB module 150-2, which is implemented as computer program code 153 and is executed by the one or more processors 152. For instance, the one or more memories 155 and the computer program code 153 may be configured to, with the one or more processors 152, cause the IAB node 1110 and/or 1120 to perform one or more of the operations in accordance with the example embodiments of the present disclosure as described herein.

The one or more network interfaces 161 communicate over a wired or wireless network such as via a corresponding wireless link e.g., via transceiver 160 or via circuitry in the network interface 161 as shown in FIG. 2B. As shown in FIG. 1B for example the IAB node 1110/1120 for instance, may use links such as via the IAB Donor 1130 to communicate with the NGC 1140, and through this element 1140 to other network(s) and/or the Internet. The one or more buses 157 may be address, data, or control buses, and may include any interconnection mechanism, such as a series of lines on a motherboard or integrated circuit, fiber optics or other optical communication equipment, wireless channels, and the like.

The wireless network 100 shown in FIG. 2A may include a network element or elements, for example NGC 1140 that may include core network functionality, and which provides connectivity with a further network, such as a telephone network and/or a data communications network (e.g., the Internet). Such core network functionality for 5G may include access and mobility management function(s) (AMF(S)) and/or user plane functions (UPF(s)) and/or session management function(s) (SMF(s)).

Although primary emphasis is placed herein on 5G as an example, other technology may be used. For instance, core network functionality for LTE may include MME (Mobility Management Entity)/SGW (Serving Gateway) functionality. These are merely example functions that may be supported by the wireless communication system 100 as shown in FIG. 2A and note that both 5G and LTE functions might be supported. The IAB nodes 1110 and 1120 and Donor node 1130 could be gNB nodes for 5G, for instance, and eNB nodes for 4G, or there could be a combination of gNB and eNB nodes or other base stations, e.g., for other technologies.

The computer readable memories 155 in FIG. 2B may be of any type suitable to the local technical environment and may be implemented using any suitable data storage technology, such as semiconductor-based memory devices, flash memory, magnetic memory devices and systems, optical memory devices and systems, fixed memory and removable memory. The computer readable memories 155 may be means for performing storage functions. The processors 152 may be of any type suitable to the local technical environment, and may include one or more of general purpose computers, special purpose computers, microprocessors, digital signal processors (DSPs) and processors based on a multi-core processor architecture, as non-limiting examples. The processors 152 may include means for performing functions, such as controlling the IAB donor node 1130, IAB nodes 1110 and/or 1120, and other functions as described herein.

Example embodiments of the disclosure relate to how to determine an MT/DU functionality of an IAB node in the TDM case when resources for the DU and MT parts of the IAB node are configured separately, and when resource for each IAB node is configured separately.

In one aspect of the present disclosure, there is provided methods of resource allocation which may be implemented in an IAB node, for example but not limited to, the IAB node 1120 in FIG. 1B, IAB node 1220 in FIG. 1A, or IAB node 1110 in FIG. 2A.

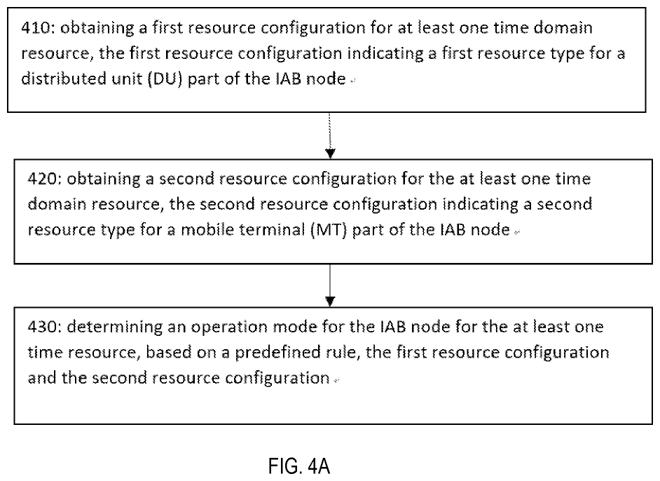

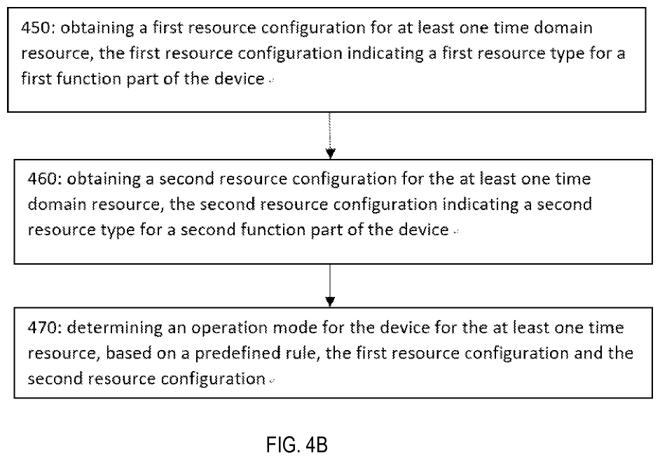

FIG. 4A illustrates operations which may be performed by a network device such as, but not limited to, an IAB node as in FIG. 2A or 2B. It should be appreciated that example embodiments of the present disclosure as described herein may also be applied to device-to-device (D2D) and/or vehicle-to-vehicle (V2V) communications, in which the method may be implemented by a device. As shown in block 410 of FIG. 4A there is obtaining a first resource configuration for at least one time domain resource, the first resource configuration indicating a first resource type for a distributed unit (DU) part of the IAB node (or a first function part in a D2D/V2X device, in an embodiment where the method is applied in a D2D/V2X scenario). As shown in block 420 of FIG. 4A there is obtaining a second resource configuration for the at least one time domain resource, the second resource configuration indicating a second resource type for a mobile terminal (MT) part of the IAB node (or a second function part in a D2D/V2X device, in an embodiment where the method is applied in a D2D/V2X scenario). Then as shown in block 430 of FIG. 4A there is determining an operation mode for the IAB node (or D2D/V2X device) for the at least one time resource, based on a predefined rule, the first resource configuration and the second resource configuration.

In some embodiments, the predefined rule may include: selecting an operation mode A when one of the following is satisfied: 1) “DU configuration” is Hard, 2) DU configuration is Soft with an indication available to use soft resources, and 3) MT configuration is Flexible and DU configuration is Soft with an indication available to use soft resources.

It should be appreciated that when the method is implemented in a D2D/V2X scenario, the “DU configuration” and “MT configuration” may be replaced with configuration for the first function part of a device and configuration for the second function part of the device respectively.

Alternatively, or in addition, the predefined rule may include: selecting an operation mode B when DU configuration is NA or Soft with no indication available to use soft resources.

In some embodiments, the mode A and mode B may define the following operations for the DU and MT parts of the IAB node:
mode A: MT is set to NULL, DU is Not-NULL (i.e., DU may perform DL, UL, or DL/UL operation)
mode B: DU is set to NULL, MT us Not-NULL (i.e., MT may perform DL, UL, or DL/UL operation).

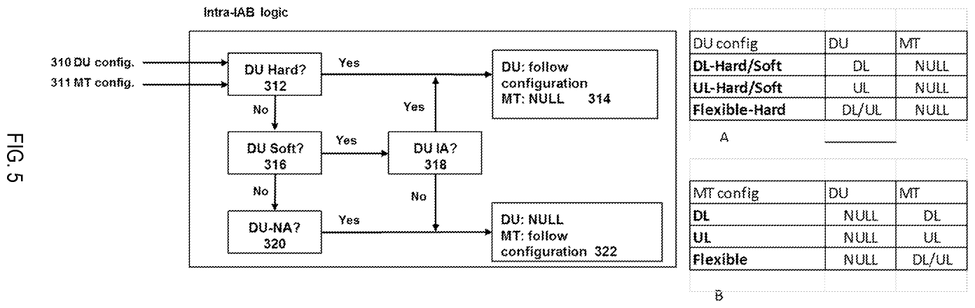

One example of the predefined rule (Intra-IAB logic) proposed in the present disclosure for determining DU/MT behaviour of an IAB node is illustrated schematically in FIG. 5.

As shown in FIG. 5, the IAB node determines operations for the DU part and the MT part based on input parameters, which include a DU resource configuration 310 and an MT resource configuration 311. At block 312 of FIG. 5, there is determining whether a DU resource configuration indicates a Hard resource type for the DU. If Yes at block 312, block 314 of FIG. 5 is performed, where the IAB node determines that the DU follows its resource configuration 310 while the MT operation is set to Null, which means that no transmission or reception is to be performed by the MT part. This operation mode is shown in Table A of FIG. 5. DU DL in Table A may correspond to at least one of the following: 1) DU may operate according to a DL configuration 2) DU may transmit. DU UL may correspond to at least one of the following: 1) DU may operate according to an UL configuration 2) DU may receive. DU DL/UL may correspond to at least one of the following: 1) DU may operate according to a flexible configuration 2) DU may transmit or receive.

If No at block 312, then the IAB node may determine if DU Soft resource is configured, based on the DU resource configuration 310, as shown at block 316 of FIG. 5. If yes at block 316 (i.e., the resource is configured to be a Soft type for the DU), the procedure may proceed to block 318 of FIG. 5 where the IAB node determines whether the resource is indicated as available (IA) for the DU. If Yes at block 318 of FIG. 5, then block 314 of FIG. 5 is performed.

On the other hand, if no at block 316 of FIG. 5 (i.e., the resource is not configured to be a Soft type for DU), then the procedure proceeds to block 320 of FIG. 5, where the IAB node determines whether the resource is configured as Not Available (NA) for the DU.

If No at block 318, or yes at block 320, the procedure proceeds to block 322, where the IAB sets the operation of the DU to Null and makes the MT follow its resource configuration 311. This operation mode is shown in Table B of FIG. 5. MT DL in Table B may correspond to at least one of the following: 1) MT may operate according to a DL configuration 2) MT may receive. MT UL may correspond to at least one of the following: 1) MT may operate according to an UL configuration 2) MT may transmit. MT DL/UL may correspond to at least one of the following: 1) MT may operate according to a flexible configuration (e.g. according to NR Rel-15 rules) 2) MT may transmit or receive.

As described with reference to FIG. 5, in some embodiments, input parameters for the Intra-IAB logic (rules) for determining DU/MT operation may comprise (but not limited to) DU resource configuration (e.g., DU resource configuration 310 in FIG. 5) and MT resource configuration (e.g., MT resource configuration 311 in FIG. 5). As an example, the DU resource configuration may indicate a resource type for the DU part of the IAB node for a time domain resource. The resource type may be one of: Hard (for a link direction of DL, UL or Flexible), Soft (for a link direction of DL, UL, or Flexible), and Not Available (NA). Here, Flexible means the link direction may be DL or UL.

In some embodiments, the MT resource configuration may indicate a resource type for the MT part of the IAB node for a time domain resource. The resource type may be one of: DL resource, UL resource, and Flexible resource (i.e., DL or UL resource).

In the above embodiments of FIG. 5, a “DL” resource for the DU part refers to a time domain resource schedulable for Child link transmission (by the DU), and a “DL” resource for the MT part refers to a time domain resource available for BH link reception (which may be scheduled by a parent node).

Likewise, an “UL” resource for the DU part refers to a time domain resource schedulable for Child link reception (which is scheduled by the DU), and an “UL” resource for the MT part refers to a time domain resource available for BH link transmission (which may be scheduled by a parent node).

In some embodiments, an “UL/DL” resource means a flexible time domain resource, which can be used as DL or UL based on the scheduling node's decision or other signalling received e.g. from the parent node.

In some embodiments, the output parameter for the IAB internal logic (rules) for determining DU/MT operation may comprise (but is not limited to) a determined operation mode for the IAB node.

For illustration rather than limitation, the determined operation mode may include one of: an operation mode A and an operation mode B. Each operation mode defines operations for the DU and the MT parts of the IAB node.

In some embodiments, the DU operation may include DL, UL, Flexible (DL/UL), or Null, and the MT operation may include DL, UL, Flexible (DL/UL) or Null.

The determined operation mode depends on input parameters, e.g., DU resource configuration and MT resource configuration, as shown in FIG. 5. For example, the IAB node may set its DU operation configuration to “NULL” for a resource where DU resource configuration indicates NA, or Soft with no indication available (implicitly not available, INA) to use soft resources. Alternatively, or additionally, the IAB node may set its MT operation configuration to “NULL” for a resource where the DU resource configuration indicates Hard, or Soft with an indication available (IA) to use soft resources.

Note that, for a given resource, only one component (DU or MT) of the IAB node will be configured as “NULL”. “NULL” in the above may refer as no transmission or reception by the corresponding component (DU or MT). It should be noted that DU may also decide not to use certain resource DL, UL, or flexible (DL/UL) by it's own (scheduling) decision.

FIG. 6 shows an example of valid and invalid resource combinations for an IAB node when the DU part has been configured as Soft resource according to embodiments of the present disclosure.

In the example scenario considered in FIG. 6, only a flexible resource (for MT) can be used as a soft resource (for DU). As a result, some resource configuration combinations of DU and MT that do not comply with this resource constraint are considered as error cases, as show in FIG. 6. In the example shown in FIG. 6, the combinations marked with “x” are considered as error cases (e.g. in the sense that DU Soft is always NA). For these error cases, the IAB node may not determine the availability of the DU resource, or the IAB node may interpret the corresponding resource as “NA” for the DU. This approach provides clear benefits: 1) undesirable cross-link interference in the network can be avoided (access link UE's in the parent cell may operate according to NR Release 15); 2) introduction of new functionality for MT part of the IAB node compared to Rel-15 operation can be avoided. According to NR Rel-15 principles: DL, UL are not conditionally available for the UE (but always available). Based on that, DL and UL cannot be overridden by semi-static SFI (slot format indication), RRC configuration or dynamic DCI. Hence, the UE does not determine availability of the resources configured as DL or UL.

In some embodiments, by considering the resource constraint illustrated in FIG. 6, the predefined rule used for determining the operation mode of the IAB node e.g., at block 430 of FIG. 4A may comprise: in response to the first resource type being Soft and the second resource type not being Flexible (e.g., the second resource type indicating DL resource, or indicating UL resource), determining a first operation mode (e.g., Mode B) for the IAB node (or a D2D/V2X device in a D2D/V2X scenario) where the DU part (or the first function part of the D2D/V2X device in a D2D/V2X scenario) does not transmit and does not schedule uplink transmission from any child node and terminal device.

FIG. 7 shows an example of such an intra-IAB logic (rules) for determining DU/MT operation and TDM between parent and child links by considering the resource constraint illustrated in FIG. 6. It should be appreciated that examples of the predefined rules described herein may also be applied to device-to-device (D2D) and/or vehicle-to-vehicle (V2V) communications, in which similar procedure may be implemented by a device for determining an operation mode of a D2D/V2X device, where each operation mode may define operations of a first function part and a second function part of the D2D/V2X device.

As shown in FIG. 7 there is a DU Configuration 410 and an MT Config. 420. At block 412 of FIG. 7 there is determining whether a DU configuration is DU Hard. If Yes, then the procedure proceeds to block 414 of FIG. 7, where it is determined that the DU follow the configuration and MT is set to Null. This is shown in Table A of FIG. 7. If No at block 412, then the procedure proceeds to block 416, where it is determined if resource configuration for the DU part is DU Soft. If yes, the procedure may further proceed to block 417 of FIG. 7, where it is determined whether the resource is considered as MT Flexible or not. If No at block 416 then as shown in block 420 of FIG. 7, the IAB node determines if the resource is configured to be DU-NA, i.e., unavailable for DU. If yes at block 420 of FIG. 7, then the operation of the DU is set to be Null and the operation of the MT follows the configuration, as shown in block 422.

If No at block 417 of FIG. 7, same operation mode (i.e., Mode B) is determined in block 422. This is shown in Table B of FIG. 7.

If Yes at block 417, then at block 418 the IAB node determines whether resource is indicated as DU IA. If yes at block 418, the operation of the DU follow the configuration 410 and the operation of the MT is set to Null in block 414. This operation mode is shown in Table A of FIG. 7.

If No at block 418, the procedure proceeds to block 422 where the operation of the DU is set to NULL and the operation of the MT follow the configuration 420.

The function of the block 418 “DU IA?” in FIG. 7 is similar to that of block 318 in FIG. 5, i.e., to determine whether a Soft resource for the DU is explicitly or implicitly indicated as Available (IA).

A benefit of the approaches illustrated in FIG. 5 and FIG. 7 is that MT functionality defined in R15 can be used for determining the resource usage of a BH resource (DL/UL/Not assigned) as such for example at the “DU IA?” block 318 in FIG. 5 and block 418 in FIG. 7. On the other hand, in terms of IAB node operation, the functionality shown in FIG. 7 does not limit the dynamic capacity allocation between parent BH and child links at all e.g. compared to that of FIG. 5.

In some example embodiments of the disclosure, the determination at block 318 in FIG. 5 or block 418 in FIG. 7 (i.e., the “DU IA?” block) may be based on one or more of the following:
Semi-static resource configuration obtained from a centralized unit (CU). This can be made e.g. based on existing R15 signalling TDD-UL-DL-ConfigurationCommon, or TDD-UL-DL-ConfigDedicated enhanced by new resource types defined for DU (DU Hard (for DL, UL, or Flexible), DU Soft (e.g., DL-soft, UL-soft, Flexible-soft), NA);
RRC configured DL signals, including but not limited to, PDCCH, PDSCH, or CSI-RS;
RRC configured UL signals, including but not limited to, SRS, or PUCCH, or PUSCH, or PRACH;
Dynamic DCI received from a parent node. For example, resources may be scheduled as UL/DL by different DCI formats.
Group-common DCI (such as DCI format 2_0) received from the parent node;
Other explicit indication received from the parent node; and/or
Rel-15 prioritization rules defined in TS 38.213 (Section 11.1).

In some embodiments, some operation(s) of the proposed method may be performed based on NR R15 rules. For example:
MT may determine the resource usage for flexible resources according to rules defined in TS 38.213 (Section 11.1) and/or based on received DCI/higher layer configuration; and
The Availability of a DU resource (e.g., determined at block 318 of FIG. 5 or block 418 of FIG. 7) may depend on the resource type determined by MT.

In some embodiments, if the resource is occupied by the MT (for DL or UL), it is not available for DU. That is, the DU resource is explicitly or implicitly indicated as not available (INA).

Alternatively, or in addition, if a resource is not occupied by the MT, or if the parent node explicitly indicates the resource as available for the DU, the resource is considered as available for DU. That is, the DU resource is explicitly or implicitly indicated as available (IA).

In some embodiments, a time domain resource may correspond to a time slot; however, it should be appreciated that embodiments of the present disclosure are not limited thereto. Instead, any time resource granularity may be used based on needs. For example, in some embodiments, the resource configuration and the operation determination for DU/MT can be done in (OFDM) symbol resolution. In other words, solutions described with reference to FIGS. 5 and 7 may be performed per symbol or time slot.

It should be appreciated that the process shown in FIG. 5 and FIG. 7 may start from any of the left blocks (i.e., blocks 312, 314 and 324 in FIG. 5, and blocks 412, 416 and 420 of FIG. 7) of the logic for determining DU/MT operations of the IAB node. For example, the IAB node may firstly check whether the resource is NA for DU based on the DU resource allocation (i.e., block 320 in FIG. 5 or block 420 in FIG. 7 may be performed firstly). In this case, the procedure may proceed to other blocks based on checking result at block 320 or 420.

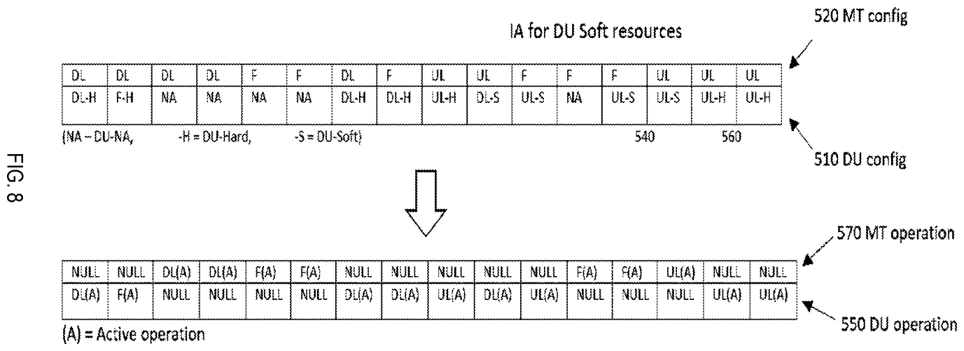

FIG. 8 shows an example embodiment where the DU resources are categorized as Hard, Soft, and NA. Also, we consider that a part of the Soft DU resources (e.g., according to FIG. 5) are indicated as Available. By using the proposed resource allocation scheme (e.g., predefined rules as shown in FIG. 5 or FIG. 7, or method shown in FIG. 4A and/or FIG. 4B), the Hard DU resources and Soft DU resources with Available indication are allocated to the DU, i.e., the DU may operate according to its DU resource configuration DU configuration 510 in these resources in the IAB operation mode, while rest of the resources (NA DU resources and Soft DU resources with no Available indication) are allocated to the MT, i.e., the MT may operate following its MT resource configuration MT configuration 520 in the rest resources, resulting in MT operation 570 and DU operation 550 shown in FIG. 8. This scheme helps to avoid Intra-IAB MT/DU conflicts. When considering DU link, there are resources with IA and resources with INA. In the case when DU soft resources is IA, the IAB node will operate according to DU config, and when DU resources is INA, the IAB node will operate according to MT configuration.

In the example shown in FIG. 8, each time domain resource corresponds to one time slot. However, it should be noted that resource configuration may be done also in other granularities, e.g., with symbol level resolution. Identifiers “H”, “S” and “NA” in FIG. 8 show the categorization of DU resources as Hard, Soft, and NA. That is, in some example embodiments, the first resource type as described with reference to method 400 may be one of: Hard, Soft and Not available.

In some example embodiments, the first resource configuration obtained at block 410 of FIG. 4A may further indicate a link direction for the DU part, and the link direction may be one of: downlink, uplink and flexible.

In some example embodiments, the second resource type may include one of: Downlink, Uplink and Flexible.

In some example embodiments, the operation mode determined by the IAB node, for example at block 430 of FIG. 4A may include one of: the first operation mode, where the DU part does not transmit and does not schedule uplink transmission from any child node and UEs, while the MT part operates according to the second resource configuration; and a second operation mode, where the MT part does not transmit or receive, while the DU part operates according to the first resource configuration.

In some example embodiments, the predefined rule for determining DU/MT operation may further comprises at least one of: in response to the first resource type being Hard, determining the second operation mode for the IAB node; in response to the first resource type being Soft, the second resource type being Flexible and/or the resource being available for the DU part, determining the second operation mode for the IAB node; in resource to the first resource type being Soft and the first resource configuration indicating resource unavailable for the DU part, determining the first operation mode for the IAB node; and in response to the first resource type being Not Available, determining the first operation mode for the IAB node. Note that, resource may be indicated (explicitly or implicitly) as being available for the DU part by the first resource configuration or the second resource configuration.

In some example embodiments, the DU part operating according to the first resource configuration may comprise at least one of: in response to the first resource configuration indicating a resource for downlink communication, the DU part performs downlink transmission; in response to the first resource configuration indicating a resource for uplink communication, the

DU part schedules uplink transmission from a child node or a terminal device; and in response to the first resource configuration indicating a resource for flexible communication, the DU part transmits in downlink or schedules an uplink.

In some example embodiments, the MT part operating according to the second resource configuration may comprise at least one of: in response to the second resource configuration indicating a resource for downlink communication, the MT part receives a downlink transmission; in response to the second resource configuration indicating a resource for uplink communication, the MT part transmits in uplink; and in response to the second resource configuration indicating a resource for flexible communication, the MT part transmits in uplink or receives in downlink.

In some example embodiments, the first or second resource configuration may be obtained via one of: a default configuration, a higher layer configuration from a centralized unit (CU), a higher layer configuration from a parent node, and a dynamic downlink control information (DCI) from the parent node.

In some example embodiments, the following priority rules may apply for the first or the second resource configuration: higher layer configuration obtained from CU overrides the default configuration; higher layer configuration obtained from parent node overrides both higher layer configuration obtained from CU and the default configuration; dynamic DCI overrides both higher layer configuration and the default configuration.

In some example embodiments, the availability of the Soft resource for DU link may be indicated by means of explicit signalling received from the parent node.

In some example embodiments, the availability of the Soft resource for DU link may be determined implicitly by one of: the soft resource is considered to be available if the corresponding MT resource is not assigned DL reception or UL transmission; and soft resource is considered to be not available if the corresponding MT resource is assigned for DL reception or UL transmission.

In some example embodiments, the availability of MT resource at the IAB node may be determined based on Rel-15 rules.

In an aspect of the present disclosure, an apparatus is proposed. As an example, the apparatus may be implemented as, or in, an IAB node. In some embodiments, the apparatus may be implemented as/in a D2D or V2X device. The apparatus comprises: means for obtaining (IAB Module 150-1 and/or 150-2, processors 152, memory(ies) 155, and CPC 153 as in FIG. 2B) a first resource configuration for at least one time domain resource, the first resource configuration indicating a first resource type for a distributed unit (DU) part of the IAB node (or a first function part of a D2D/V2V device); a means for obtaining (IAB Module 150-1 and/or 150-2, processors 152, memory(ies) 155, and CPC 153 as in FIG. 2B) a second resource configuration for the at least one time domain resource, the second resource configuration indicating a second resource type for a mobile terminal (MT) part of the IAB node (or a second function part of a D2D/V2V device); and a means for determining (IAB Module 150-1 and/or 150-2, processors 152, memory(ies) 155, and CPC 153 as in FIG. 2B) an operation mode for the IAB node (or a D2D/V2X device) for the at least one time resource, based on a predefined rule, the first resource configuration and the second resource configuration.

As an example rather than limitation, the predefined rule may comprise: in response to the first resource type being Soft and the second resource type not being Flexible, determining a first operation mode for the IAB node where the DU part does not transmit and does not schedule uplink transmission from any child node and terminal device.

It should be appreciated that other predefined rules described above with reference to FIGS. 4A, 4B, 5, 6, and/or 7 may also be used. Moreover, more than one predefined rules may be used in a combination.

In some embodiments of the disclosure, at least the means for obtaining, and means for determining may comprise a non-transitory computer readable medium [e.g., memory(ies) 155 as in FIG. 2B] encoded with a computer program [e.g., CPC 153 as in FIG. 2B] executable by at least one processor [e.g., Processors 152 as in FIG. 2B].

FIG. 4B illustrates operations in accordance with example embodiments of the disclosure which may be performed by a network device such as, but not limited to, an IAB node as in FIG. 2A or 2B.

As shown in step 450 of FIG. 4B there is obtaining a first resource configuration for at least one time domain resource, the first resource configuration indicating a first resource type for a first function part of the device. As shown in step 460 of FIG. 4B there is obtaining a second resource configuration for the at least one time domain resource, the second resource configuration indicating a second resource type for a second function part of the device. Then as shown in step 470 of FIG. 4B there is determining an operation mode for the device for the at least one time resource, based on a predefined rule, the first resource configuration and the second resource configuration.

In some example embodiments, the device comprises one of: an integrated access and backhaul (IAB) node, a D2D device, and a V2X device.

In some example embodiments, the first function part comprises a distributed unit (DU) part of an IAB node, and the second function part comprises a mobile terminal (MT) part of the IAB node.

In some example embodiments, the predefined rule comprises: in response to the first resource type being Soft and the second resource type not being Flexible (e.g., the second resource type being DL, or UL), determining a first operation mode for the device where the first function part does not transmit and does not schedule/receive uplink transmission from any child node and terminal device.

In some example embodiments, the first resource type may be one of: Hard, Soft and Not available.

In some example embodiments, the first resource configuration may further indicates a link direction for the DU part, and the link direction is one of: downlink, uplink and flexible.

In some example embodiments, the second resource type is one of: Downlink, Uplink and Flexible.

In some example embodiments, the operation mode is one of: the first operation mode, where the DU part does not transmit and does not schedule/receive uplink transmission from any child node and UEs, while the MT part operates according to the second resource configuration; and a second operation mode, where the MT part does not transmit or receive, while the DU part operates according to the first resource configuration.

In some example embodiments, the predefined rule further comprises at least one of: in response to the first resource type being Hard, determining the second operation mode for the IAB node; in response to the first resource type being Soft and the resource being explicitly or implicitly indicated as available for the DU part, determining the second operation mode for the IAB node;

in resource to the first resource type being Soft and the resource being explicitly or implicitly indicated as unavailable for the DU part, determining the first operation mode for the IAB node;

and in response to the first resource type being Not Available, determining the first operation mode for the IAB node.

In some example embodiments, the predefined rule may comprise: in response to the first resource type being Soft, the second resource type being Flexible and the resource being explicitly or implicitly indicated as available for the DU part, determining the second operation mode for the IAB node.

In some example embodiments, the DU part operating according to the first resource configuration comprises at least one of: in response to the first resource configuration indicating a resource for downlink communication, the DU part performs downlink transmission; in response to the first resource configuration indicating a resource for uplink communication, the DU part schedules and/or receives uplink transmission from a child node or a terminal device; and in response to the first resource configuration indicating a resource for flexible communication, the DU part transmits in downlink or schedules an uplink.

In some example embodiments, the MT part operating according to the second resource configuration comprises at least one of: in response to the second resource configuration indicating a resource for downlink communication, the MT part receives a downlink transmission; in response to the second resource configuration indicating a resource for uplink communication, the MT part transmits in uplink; and in response to the second resource configuration indicating a resource for flexible communication, the MT part transmits in uplink or receives in downlink.

In some example embodiments, the first resource configuration is obtained via one of: a default configuration, a higher layer configuration from a centralized unit (CU), a higher layer configuration from a parent node, and a dynamic downlink control information (DCI) from the parent node.

In some example embodiments, the default configuration indicates a resource type of “Not Available”.

In some example embodiments, the second resource configuration is obtained via one of: a default configuration, a higher layer configuration from a centralized unit (CU), a higher layer configuration from a parent node, and a dynamic downlink control information (DCI) from the parent node.

In some example embodiments, the first resource configuration and/or the second resource configuration is obtained further based on a priority rule comprising at least one of: the higher layer configuration from the CU overrides the default configuration, the higher layer configuration from the parent node overrides the higher layer configuration from the CU and the default configuration; the dynamic DCI overrides the higher layer configuration from the CU, the higher layer configuration from the parent node and the default configuration.

In some example embodiments, first resource configuration comprises an explicit signalling received from a parent node, which indicates availability of a Soft resource for the DU part.

In some example embodiments, determining availability of the Soft resource comprises at least one of: in response to the first resource configuration indicating resource available for the DU part, determining the Soft resource in the at least one time resource as Available; and in response to the first resource configuration indicating resource not available for the DU part, determining the Soft resource in the at least one time resource as Not Available.

In some example embodiments, availability of a Soft resource for the DU part is indicated via a further signalling separate from the first resource configuration.

In some example embodiments, availability of a Soft resource may be indicated by the first resource configuration for the DU part implicitly.

In some example embodiments, determining availability of the Soft resource comprises at least one of: in response to no corresponding MT resource being assigned in the at least one time resource, determining the Soft resource in the at least one time resource as Available; and in response to a corresponding MT resource being assigned in the at least one time resource, determining the Soft resource in the at least one time resource as Not Available.

In some example embodiments, whether corresponding MT resource is assigned is determined based on rules defined in New Radio (NR) Rel-15.

In an aspect of the present disclosure, an apparatus is proposed. As an example, the apparatus may be implemented as, or in, an IAB node. In some embodiments, the apparatus may be implemented as/in a D2D or V2X device. The apparatus comprises: means for obtaining (IAB Module 150-1 and/or 150-2, processors 152, memory(ies) 155, and CPC 153 as in FIG. 2B) a first resource configuration for at least one time domain resource, the first resource configuration indicating a first resource type for a first function part of the device; means for obtaining (IAB

Module 150-1 and/or 150-2, processors 152, memory(ies) 155, and CPC 153 as in FIG. 2B) a second resource configuration for the at least one time domain resource, the second resource configuration indicating a second resource type for a second function part of the device; and means for determining (IAB Module 150-1 and/or 150-2, processors 152, memory(ies) 155, and CPC 153 as in FIG. 2B) an operation mode for the device for the at least one time resource, based on a predefined rule, the first resource configuration and the second resource configuration.

It should be appreciated that other predefined rules described above with reference to FIGS. 4A, 4B, 5, 6, and/or 7 may also be used. Moreover, more than one predefined rules may be used in a combination.

In some embodiments of the disclosure, at least the means for obtaining, and means for determining may comprise a non-transitory computer readable medium [e.g., memory(ies) 155 as in FIG. 2B] encoded with a computer program [e.g., CPC 153 as in FIG. 2B] executable by at least one processor [e.g., Processors 152 as in FIG. 2B].

In general, the various embodiments of the mobile station [e.g., UEs 10, 20, and/or 30 as in FIG. 2A] may include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this disclosure may be implemented by computer software executable by a data processor of the mobile station [e.g., UEs 10, 20, and/or 30 as in FIG. 2A], such as the processor [Processor(s)] 152 as in FIG. 2B], or by hardware, or by a combination of software and hardware. Further in this regard it should be noted that the various blocks of the logic flow diagram of at least FIG. 4A, FIG. 4B, FIG. 5, and FIG. 7 may represent program, or interconnected logic circuits, blocks and functions, or a combination of program and logic circuits, blocks and functions. It is noted that any of these devices may have multiple processors (e.g. RF, baseband, imaging, user interface) which operate in a slave relation to a master processor. The teachings may be implemented in any single one or combination of those multiple processors.

The memory [or memories 155 shown in FIG. 2A] may be of any type suitable to the local technical environment and may be implemented using any suitable data storage technology, such as semiconductor-based memory devices, magnetic memory devices and systems, optical memory devices and systems, fixed memory and removable memory. The data processors [e.g., Processor(s) 152 as in FIG. 2B] may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the disclosures may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are example embodiments provided to enable persons skilled in the art to make or use the disclosure and not to limit the scope of the disclosure which is defined by the claims.

The foregoing description has provided by way of example and non-limiting examples a full and informative description of the best method and apparatus presently contemplated by the inventors for carrying out the disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this disclosure.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of example embodiments of this disclosure could be used to advantage without the corresponding use of other features. As such, the foregoing description should be considered as merely illustrative of the principles of the disclosure, and not in limitation thereof.

1. An apparatus comprising:
at least one processor, and
at least one memory including computer program code;
the at least one memory and the computer program code are configured, with the at least one processor, to cause the apparatus to:
obtain a first resource configuration for at least one time domain resource, the first resource configuration indicating a first resource type for a first function part of the apparatus, the first resource type being one of: Hard, Soft or Not Available;
obtain a second resource configuration for the at least one time domain resource, the second resource configuration indicating a second resource type for a second function part of the apparatus, the second resource type being one of: Downlink, Uplink or Flexible; and
determine an operation mode for the apparatus for the at least one time domain resource, based on a predefined rule, the first resource configuration and the second resource configuration;
wherein the predefined rule comprises:
in response to the first resource type being Soft and the at least one time domain resource being not occupied by the second function part, determine a first operation mode for the apparatus where the second function part does not transmit or receive and the first function part is available for transmission or reception.

2. The apparatus of claim 1, wherein the apparatus comprises one of:
an integrated access and backhaul (IAB) node,
a device-to-device communication D2D device, or
a vehicle to anything device.

3. The apparatus of claim 2, wherein the first function part comprises a distributed unit part of an IAB node, and the second function part comprises a mobile terminal part of the IAB node.

4. The apparatus of claim 1, wherein the operation mode is one of:
the first operation mode; or
a second operation mode, where the first function part does not transmit or receive, while the second function part is available for transmission or reception according to the second resource configuration.

5. The apparatus of claim 4, wherein predefined rule further comprises one or more of:
in response to the first resource type being Soft and the second resource type not being Flexible, determine the second operation mode for the apparatus;
in response to the first resource type being Hard, determine the first operation mode for the apparatus;
in response to the first resource type being Soft and the at least one time domain resource being explicitly or implicitly indicated as available for the first function part, determine the first operation mode for the apparatus;
in response to the first resource type being Soft and the at least one time domain resource being explicitly or implicitly indicated as unavailable for the first function part, determine the second operation mode for the apparatus;
in response to the first resource type being Not Available, determine the second operation mode for the apparatus;
in response to the first resource type being Soft and the at least one time domain resource being occupied by the second function part, determine the second operation mode for the apparatus; and
in response to the first resource type being Soft, the second resource type being Flexible and the at least one time domain resource being explicitly or implicitly indicated as available for the first function part, determine the first operation mode for the apparatus.

6. The apparatus of claim 1, wherein the first resource configuration further indicates a link direction for the first function part, and the link direction is one of: downlink, uplink or flexible.

7.-8. (canceled)

9. The apparatus of claim 1, wherein first resource configuration further comprises an explicit signalling received from a parent node, the explicit signalling indicating availability of a Soft resource for the first function part.

10. The apparatus of claim 1, wherein the at least one memory and the computer program code are further configured, with the at least one processor, to cause the apparatus to:
receive a further signalling separate from the first resource configuration, the further signalling indicating availability of a Soft resource for the first function part.

11. The apparatus of claim 1, wherein the at least one memory and the computer program code are further configured, with the at least one processor, to cause the apparatus to:
determine availability of a resource indicated by the first resource configuration for the first function part implicitly based on whether the resource is occupied by the second function part.

12. The apparatus of claim 11, wherein determination of the availability of the resource comprises at least one of:
determine a Soft resource in the at least one time domain resource as Available, if a corresponding resource is not assigned for the second function part in the at least one time domain resource; or
determine a Soft resource in the at least one time domain resource as Not Available, if a corresponding resource is assigned for the second function part in the at least one time domain resource.

13. A method for a device, comprising:
obtaining a first resource configuration for at least one time domain resource, the first resource configuration indicating a first resource type for a first function part of the device, the first resource type being one of: Hard, Soft or Not Available;
obtaining a second resource configuration for the at least one time domain resource, the second resource configuration indicating a second resource type for a second function part of the device, the second resource type being one of: Downlink, Uplink or Flexible; and
determining an operation mode for the device for the at least one time domain resource, based on a predefined rule, the first resource configuration and the second resource configuration;
wherein the predefined rule comprises:
in response to the first resource type being Soft and the at least one time domain resource being not occupied by the second function part, determining a first operation mode for the device where the second function part does not transmit or receive; and the first function part is available for transmission or reception.

14. The method of claim 13, wherein the device comprises an integrated access and backhaul (IAB) node, the first function part comprises a distributed unit part of the IAB node, and the second function part comprises a mobile terminal part of the IAB node.

15. The method of claim 13, wherein the operation mode is one of:
the first operation mode; or
a second operation mode, where the first function part does not transmit or receive, while the second function part is available for transmission or reception according to the second resource configuration.

16. The method of claim 15, wherein predefined rule further comprises one or more of:
in response to the first resource type being Soft and the second resource type not being Flexible, determine the second operation mode for the device;
in response to the first resource type being Hard, determine the first operation mode for the device;
in response to the first resource type being Soft and the at least one time domain resource being explicitly or implicitly indicated as available for the first function part, determine the first operation mode for the device;
in response to the first resource type being Soft and the at least one time domain resource being explicitly or implicitly indicated as unavailable for the first function part, determine the second operation mode for the device;
in response to the first resource type being Not Available, determine the second operation mode for the device; or
in response to the first resource type being Soft, the second resource type being Flexible and the at least one time domain resource being explicitly or implicitly indicated as available for the first function part, determine the first operation mode for the device.

17. The method of claim 13, wherein the first resource configuration further indicates a link direction for the first function part, and the link direction is one of: downlink, uplink or flexible.

18.-19. (canceled)

20. The method of claim 13, wherein the first resource configuration further comprises an explicit signalling received from a parent node, the explicit signalling indicating availability of a Soft resource for the first function part.

21. The method of claim 13, further comprising: receiving a further signalling separate from the first resource configuration, the further signalling indicating availability of a Soft resource for the first function part.

22. The method of claim 13, further comprising: determining availability of a resource indicated by the first resource configuration for the first function part implicitly based on whether the resource is occupied by the second function part.

23. The method of claim 22, wherein determining the availability of the Soft resource comprises at least one of:
determining a Soft resource in the at least one time domain resource as Available, if a corresponding resource is not assigned for the second function part in the at least one time domain resource; and
determining a Soft resource in the at least one time domain resource as Not Available, if a corresponding resource is assigned for the second function part in the at least one time domain resource.

24. (canceled)

25. A computer program product, comprising at least one non-transitory computer-readable storage medium having computer-executable program instructions stored therein, the computer-executable instructions configured to, when executed by an apparatus, cause the apparatus to a method comprising:
obtaining a first resource configuration for at least one time domain resource, the first resource configuration indicating a first resource type for a first function part of the apparatus, the first resource type being one of: Hard, Soft or Not Available;
obtaining a second resource configuration for the at least one time domain resource, the second resource configuration indicating a second resource type for a second function part of the apparatus, the second resource type being one of: Downlink, Uplink or Flexible; and
determining an operation mode for the apparatus for the at least one time domain resource, based on a predefined rule, the first resource configuration and the second resource configuration;
wherein the predefined rule comprises:
in response to the first resource type being Soft and the at least one time domain resource being not occupied by the second function part, determining a first operation mode for the apparatus where the second function part does not transmit or receive; and the first function part is available for transmission or reception.
